(19) United States
(12) Patent Application Publication
(10) Pub. No.: US 2023/0334775 A1
(43) Pub. Date: Oct. 19, 2023

(54) VR Capture and Playback

(71) Applicant: Meta Platforms Technologies, LLC, Menlo Park, CA (US)

(72) Inventors: Hyunbin PARK, Redwood City, CA (US); Tali ZVI, San Carlos, CA (US); Michal HLAVAC, Seattle, WA (US); Roman Georg RAEDLE, Palm Desert, CA (US); Bradley POTTERBAUM, Seattle, WA (US); Arielle Michal SHEKEL, New York, NY (US); Georgina SHEEDY-COLLIER, Los Gatos, CA (US); Shavonne YU, Menlo Park, CA (US); Gregory KUJDA, Long Beach, CA (US)

(21) Appl. No.: 18/338,743

(22) Filed: Jun. 21, 2023

Related U.S. Application Data
(60) Provisional application No. 63/371,330, filed on Aug. 12, 2022.
(60) Provisional application No. 63/370,268, filed on Aug. 3, 2022.
(60) Provisional application No. 63/354,137, filed on Jun. 21, 2022.

(51) Int. Cl. G06T 17/00; G06T 7/70

(52) U.S. Cl. CPC G06T 17/00; G06T 7/70

(57) ABSTRACT

In some implementations, the disclosed systems and methods can automatically generate seller listing titles and descriptions for products; set a follow-me mode for various virtual objects. In some implementations, an artificial reality device can generate a virtual reality environment where a user authorizes a potential spectator as a registered spectator by registering an account of the potential spectator with an account of the user. In some implementations, the disclosed systems and methods can capture video from within a virtual reality (VR) environment using one or more virtual cameras.

### CROSS REFERENCE TO RELATED APPLICATIONS

This application claims priority to U.S. Provisional application nos. 63/354,137 filed Jun. 21, 2022 and titled “User Pose Tracking for Virtual Camera Control,” and 63/370,268 filed Aug. 3, 2022 and titled “Virtual Reality Spectator Mode,” and U.S. Provisional application nos. 63/371,330 filed Aug. 12, 2022 and titled “Video from Virtual Reality,” all of which are incorporated herein by reference in their entireties.

### BACKGROUND

Artificial reality (XR) can create immerse experiences for users by providing a first-person point of view (POV) of an XR environment. A typical XR system might include a headset worn around the user's eyes, enabling the user to see an XR environment from the perspective of a player character or avatar from a first person POV. In such systems, the user's head movements are measured by sensors in the headset, which can be interpreted by an application running on the XR system as inputs that change the view of the user within the XR environment—allowing the user to intuitively change their perspective within the XR environment.

Without such headset-based XR systems, buttons and/or joysticks are typically used to adjust the position and orientation of a virtual camera within an XR environment. While traditional input devices can be effective, they may be unintuitive for inexperienced users, and may generally reduce the level of immersion experienced by the user. As a result, it can be difficult to create immerse experiences with an intuitive way to enable users to view an XR environment without the use of either traditional input devices or sensor-equipped headsets.

Parents have long been concerned about what their children see on their screens. With TVs, computers, and phones, the screen is exposed, and so a parent could see what the child saw, giving the parent the ability to understand what the child was experiencing and to approve or disapprove the content or activity. With older or more mature children, e.g., teenagers, a relationship of trust could be developed, using an “over the shoulder” or “open door” policy. The parent and child would agree that the parent would not continually observe the child's screen. Instead, the child would agree that the parent can look over the child's shoulder or through the door to monitor the screen. In return, the parent would agree to check the screen only occasionally or if the child needs help.

Artificial/virtual reality devices are becoming more prevalent and present a difficulty not found with previous types of screens. The VR headset fits over the user's face, and so no one else can directly see the screen. This means that the parent has no way to monitor the screen in a manner comparable to an “over the shoulder” or “open door” policy. Instead, the child might be required to cast the session to an exposed screen, e.g., the living room TV, so that the parent could observe. However, casting the VR session to the living room TV entails a loss of all privacy and utilizes significant computing resources of the artificial reality device. Moreover, casting to the TV in these circumstances would require the child to set up a casting session each time he wanted to use the VR headset.

As artificial/virtual reality devices have advanced to offer better and more intuitive features, more and more people enjoy having social interactions in virtual reality (VR). For example, a group of friends may decide to have a picnic in a VR world, rather than in a real-world picnic area. Each friend brings lunch, and together they can eat, talk, and play games. Also, just as in a real-world picnic, in a VR world picnic, the friends may wish to make a recording of the fun, to enjoy later and to share with their friends and family. Sophisticated VR worlds are being developed to give users more options in how to organize these social interactions. For example, there are VR online video games with an integrated game creation systems that allows creators to develop new worlds and sell the opportunity for experiences in these worlds.

### SUMMARY

Aspects of the present disclosure are directed to a virtual camera control system that adjusts the field of view of a virtual camera based on a user's position and orientation relative to a physical camera. The virtual camera control system determines a vector representing the direction of the user's gaze from an image of the user based on the orientation of the user's head or body, the position of the user within the frame of the image, and/or the position of the user's pupils. Based on the determined vector, the virtual camera control system can change the position and/or orientation of a virtual camera in a virtual environment. The techniques disclosed herein can be used, for example, to create a parallax effect when viewing a virtual environment on a TV, monitor, or laptop screen, or can otherwise be used as a hands-free method of adjusting a virtual camera in a virtual environment.

Further aspects of the present disclosure are directed to a method for implementing a spectator mode in a virtual reality environment. An artificial reality device can generate a virtual reality environment where a user authorizes a potential spectator as a registered spectator by registering an account of the potential spectator with an account of the user. The user may then receive, at the device, a request from the registered spectator for permission to operate in a spectator mode during a VR session of the user on the device. The spectator mode enables the spectator to communicate with the user during the VR session. The user can permit the registered spectator to operate in the spectator mode during the VR session. The spectator mode may further enable the registered spectator to activate one or more controls during the VR session.

Additional aspects of the present disclosure are directed to a method for capturing a video from within a virtual reality (VR) environment using one or more virtual cameras. The method includes spawning one or more virtual cameras in the VR environment, activating the one or more virtual cameras to capture respective viewpoints of events in the VR environment, and generating a video based on the captured viewpoints. The method further includes sharing the generated video to a social media platform, editing the shared video on the social media platform to generate an edited video, and posting the edited video on the social media platform.

### BRIEF DESCRIPTION OF THE DRAWINGS

FIG. 1 is a conceptual diagram illustrating a user controlling a virtual camera by turning their head in the horizontal direction.

FIG. 2 is a conceptual diagram illustrating a user controlling a virtual camera by tilting their head in the vertical direction.

FIG. 3 is a conceptual diagram illustrating a user controller a virtual camera by moving in the horizontal direction.

FIG. 4 is a conceptual diagram illustrating a user controlling a virtual camera by moving in the vertical direction.

FIG. 5 is a flow diagram illustrating a process used in some implementations of the present technology for controlling a virtual camera.

FIG. 6a is an exemplary view into a playing user's dashboard on which the spectator mode may be requested.

FIG. 6b is an exemplary view into a viewing user's dashboard on which the viewing user may request spectator mode for one of multiple connected accounts.

FIG. 7 is an exemplary view into a playing user's VR session in which the spectator mode is active.

FIG. 8 is a flow diagram illustrating a process for beginning the spectator mode used in some implementations.

FIG. 9 is a flow diagram illustrating a process for performing registration for cross account casting used in some implementations.

FIG. 10 is a first exemplary view into a virtual reality (VR) environment showing a virtual device including multiple virtual camera viewpoints to create a video.

FIG. 11 is a second exemplary view into a virtual reality (VR) environment showing a virtual device including multiple virtual camera viewpoints to create a video.

FIG. 12 is a third exemplary view into a virtual reality (VR) environment showing multiple viewpoints captured by a virtual camera.

FIG. 13 is a fourth exemplary view into a virtual reality (VR) environment showing live streaming of a video from a virtual camera in a VR environment to a social media platform.

FIG. 14 is a flow diagram illustrating a process for capturing a video using one or more virtual cameras.

FIG. 15 is a flow diagram illustrating a process for editing a video for posting to a social media platform.

FIG. 16 is a block diagram illustrating an overview of devices on which some implementations of the present technology can operate.

FIG. 17 is a block diagram illustrating an overview of an environment in which some implementations of the present technology can operate.

### DESCRIPTION

Users experience artificial reality (XR) environments through displays, such as computer monitors, screens within virtual reality (VR) headsets, on mixed reality (MR) glasses, etc. Typically, only a portion of an XR environment is rendered at a time, with the rendered portion being determined based on various parameters of a virtual camera. For example, in a first person-based video game, the portion of the XR environment visible to the user might reflect the position and orientation of the user's in-game avatar or player character. Virtual cameras are commonly controlled via one or more input devices—such as joysticks and/or buttons—with input controls from these one or more input devices being received by the game or application and adjusting the virtual camera in response. With more sophisticated systems like VR headsets, the orientation of a virtual camera may track the orientation of a user's head, such that the user can intuitively “look around” in the XR environment in the same way that the user would look around in the real world.

Both traditional input devices and sensor-equipped headsets require hardware that physically interfaces with the user. With traditional input devices, the user must press a button, turn a knob, tilt a joystick, or otherwise provide manual input to an actuator of some type. For sensor-equipped headsets, the user physically reorients and/or repositions the device with their head movement, with the change in position and/or orientation being inferred from data from sensors such as accelerometers, gyroscopes, magnetometers, and/or inertial measurement units (IMUs). In both cases, there exists a mechanical connection between the input or sensing device and the user.

In the real world, when a person turns and/or moves their head, objects nearer to the person appear to move more than objects far from the person, such that the person experiences a parallax effect. However, when viewing a 3D XR environment on a 2D screen, objects at difference “distances” in the XR environment relative to a virtual camera are all approximately the same real-world distance from the user's eyes. As a result, the parallax effect is not perceived when the user's orientation to the 2D screen changes while viewing an XR environment, unless the position and/or orientation of the virtual camera that is used to render the visible portion of the XR environment is adjusted in concert with the movement of the user's head.

Aspects of the present disclosure are directed to a virtual camera control system that tracks the user's position and orientation (collectively, “pose”) relative to a physical camera and responsively adjusts the position and/or orientation of the virtual camera in an XR environment. In an example embodiment, a camera captures an image that includes a user. The virtual camera control system receives this image as input and processes the image to determine the user's pose relative to the camera (e.g., using a keypoint detection model and computing distance ratios between various keypoints, a 3D pose estimation model to infer head orientation, a pupil tracking algorithm to estimate the direction of a person's gaze, etc.). Based on the determined user pose, the virtual camera control system may adjust the position and/or orientation of the virtual camera in an XR environment.

An example implementation of the present virtual camera control system involves a user viewing an XR environment using a laptop computer with a built-in camera. In this example, the virtual camera control system is configured to control the virtual camera's position and orientation adjustment to be geometrically proportionate to the user's pose relative to the laptop screen and camera, such that the user experiences an XR environment on a 2D screen as if it were a 3D environment. For instance, consider an object that is positioned one meter away from the virtual camera in the XR environment, with the user being one meter away from the screen. If the user moves their head from side to side, the virtual camera may adjust its position and orientation to give the impression that the object is actually two meters away from the user—possibly enabling the user to see around the object and/or surfaces of the object not visible when directly in front of the screen. In this manner, the virtual camera control system can be used to create immersive experiences similar to that of a VR headset.

As another example, the virtual camera control system may be used to simulate the experience of “looking around” a real-world space. Consider a video chat system where one participant has a camera with a wide-angle lens. The video chat system may artificially limit the field-of-view (FOV) of the video feed that is shown to the other participant on the video chat to be less than the total FOV captured by the wide-angle lensed camera. By tracking the other participant's gaze and/or pose, the virtual camera control system may adjust the portion of the video feed that is shown to the other participant, producing the effect of that other participant “looking around” the room. Various camera systems with varying FOVs (e.g., fisheye lenses, systems with two or more cameras, etc.) may be used to capture the source video, from which a virtual camera can extract a narrower FOV as the view shown to the user by the virtual camera control system.

As described herein, a user's “gaze” generally refers to an estimated direction (e.g., a vector in 3D space) that the user is looking or facing. In some implementations, the user's gaze may be inferred from the relative position of particular keypoints on a person's face. For instance, the distance ratio between the eyes and nose of a person's face can be used to infer the “aim” or direction of that person's gaze. In other implementations, the user's gaze can be inferred using a deep neural network (DNN) trained to predict 3D pose, from which a 3D vector indicative of the user's orientation can be derived. In yet other implementations, the user's gaze may be inferred from the direction of the user's pupils.

As described herein, the term “pose” refers to a user's position and orientation relative to a reference point, such as a camera. The position of a user may be determined using computer vision techniques such as blob detection, and/or using machine learning models (e.g., object detection, semantic segmentation, keypoint detection, etc.). For example, a virtual camera control system may determine a user's position within a camera frame by determining one or more points associated with the user (e.g., bounding box vertices, semantic boundary points, facial keypoints, etc.), and then determining a centroid or other point relative to those one or more points representing the approximate center of the user's body or head. Then, the virtual camera control system can combine the position of the user in the frame with the orientation of the user (e.g., the user's gaze) to determine a vector representing the user's pose. Any suitable computer vision and/or machine learning technique used to infer the pose of a user may be referred to herein as a “pose estimation model.”

In some embodiments, the pose of the user may be determined relative to camera. In these embodiments, the position of the screen relative to the camera may be known, such that the vector representing the user's pose relative to the camera can be converted to a vector representing the user's pose relative to the screen. The position of the screen displaying a view of an XR environment relative to a camera may be calibrated or otherwise configured, such that the parallax effect can be most accurately rendered from the perspective of the user.

As described herein, a “virtual camera” refers to a virtual viewing device through which a user views a virtual or augmented environment. In a game or XR application, the virtual camera may be a controllable object or virtual device that is used to determine which portion of the XR environment to render (e.g., the FOV of a user's player character in the XR environment). For instance, some game engines provide for virtual camera objects with parameters or function calls to adjust the view that is shown to the user. In some embodiments, an augmented video chat application might implement a feature similar to a virtual camera, in which a portion of one participant's camera's FOV is shown to another participant, with the portion being selected based on the viewing participant's pose relative to their own camera and/or screen.

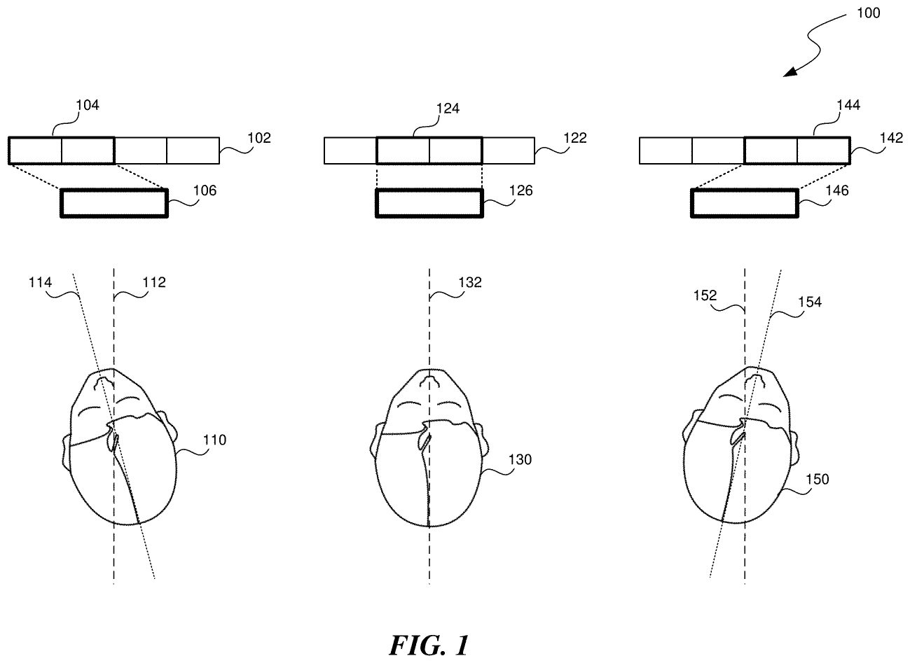

FIGS. 1-4 depict conceptual diagrams in which a virtual camera control system tracks a user's pose and responsively renders a region or portion of an XR environment to render on a screen. The virtual camera control system may include some combination of hardware and software, such as a camera, a screen, and an XR application that can determine a user's pose from image data and control which portion of an XR environment is shown on the screen to the user. Although not explicitly shown in FIGS. 1-4, the virtual camera control system can include a camera or imager that is proximate to the screen, which captures image data of the user.

FIG. 1 is a conceptual diagram 100 illustrating a user controlling a virtual camera by orienting their head in three orientations from a top-down view: orientation 110 (to the left), orientation 130 (looking straight forward), and orientation 150. When the user is looking straight forward, their orientation 130 is directly facing the screen 126, such that a centerline 132 extending through the user's pose is orthogonal to the screen 126. Accordingly, the virtual camera control system selects region 124 of XR environment 122 to render on the screen 126.

When the user turns their head to the left orientation 110, the centerline 114 of the user's gaze points to the left of the screen 106, which is not in alignment with the centerline 112 that is orthogonal to the screen 106. The virtual camera control system may compute a vector based at least in part on the centerline 114 and, in response, render region 104 of the XR environment 102 on the screen 106.

Similarly, when the user turns their head to the right orientation 150, the centerline 154 of the user's gaze points to the right of the screen 146, which is not in alignment with the centerline 152 that is orthogonal to the screen 146. As a result, the virtual camera control system may compute a vector based at least in part on the centerline 154 and, in response, render region 144 of the XR environment 142 on the screen 146. In this manner, the user is able to reorient their head horizontally to look around an XR environment, without any physical connection between the user and an input device or VR headset.

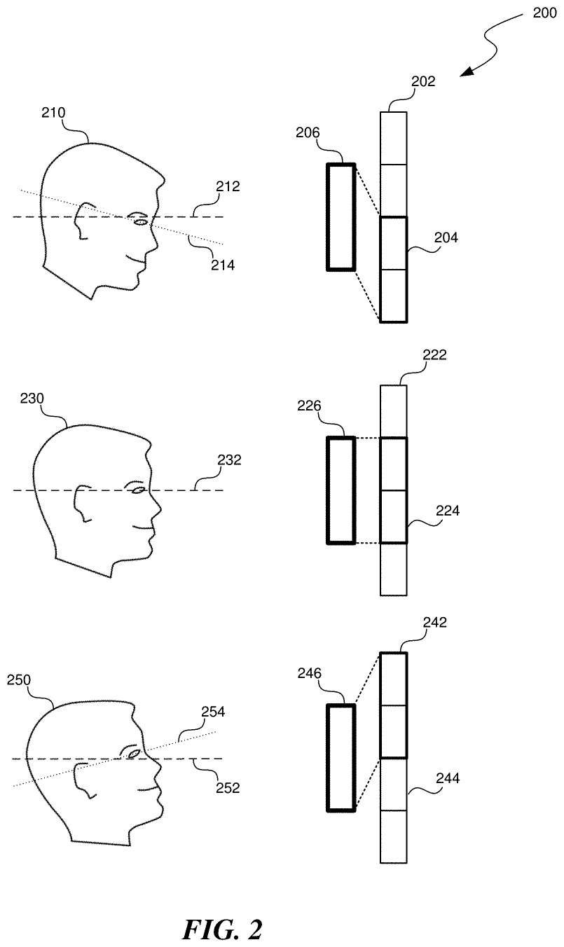

FIG. 2 is a conceptual diagram 200 illustrating a user controlling a virtual camera by tilting their head in three orientations from a side elevated view: orientation 210 (downward), orientation 230 (looking straight forward), and orientation 250 (upward). When the user is looking straight forward, the orientation 230 of their pose is directly facing the screen 226, such that a centerline 232 extending through the user's pose is orthogonal to the screen 226. Accordingly, the virtual camera control system selects region 224 of XR environment 222 to render on the screen 226.

When the user turns their head to the downward orientation 210, the centerline 214 of the user's gaze points below the screen 206, which is not in alignment with the centerline 212 that is orthogonal to the screen 206. The virtual camera control system may compute a vector based at least in part on the centerline 214 and, in response, render region 204 of the XR environment 202 on the screen 206.

Similarly, when the user turns their head to the upward orientation 250, the centerline 254 of the user's gaze points above the screen 246, which is not in alignment with the centerline 252 that is orthogonal to the screen 246. As a result, the virtual camera control system may compute a vector based at least in part on the centerline 254 and, in response, render region 244 of the XR environment 242 on the screen 246. Thus, the user is also able to reorient their head vertically to look around an XR environment, without any physical connection between the user and an input device or VR headset.

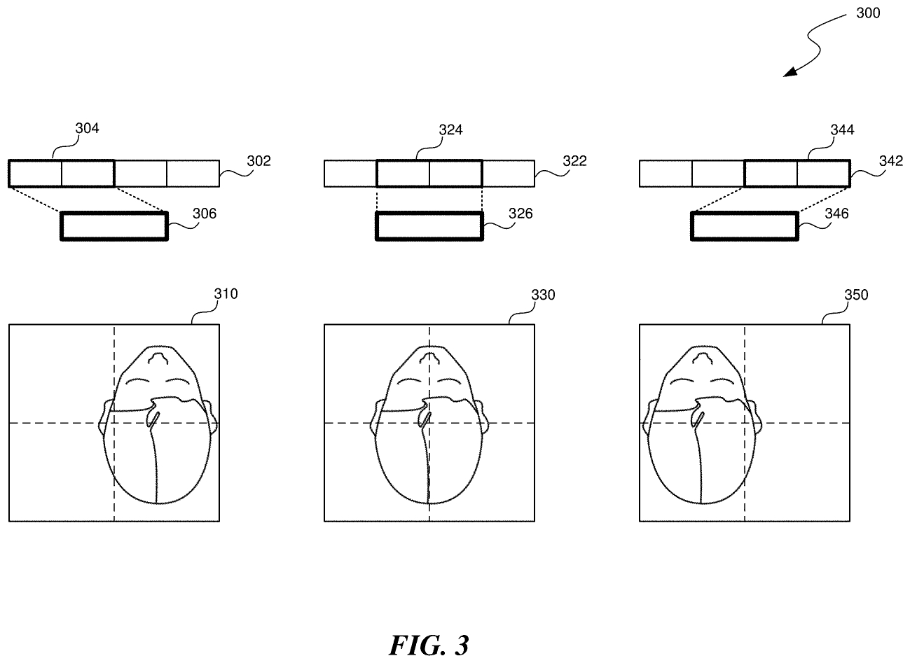

FIG. 3 is a conceptual diagram 300 illustrating a user controller a virtual camera by moving horizontally to three positions: position 310 (to the right), position 330 (centered) and position 350 (to the left). When the user is centered with the screen at position 330, the user's gaze is both directed to the center of the screen 326 and is orthogonal to the screen 326. Accordingly, the virtual camera control system selects region 324 of XR environment 322 to render on the screen 326.

When the user moves to the right position 310, the user's gaze remains orthogonal to the screen 306, but is now pointed to the right of the screen 306. Thus, the virtual camera control system may compute a vector based at least in part on the user's position 310 and, in response, render region 304 of the XR environment 302 on the screen 306 (e.g., enabling the user to see to the left of what was rendered on the screen 326).

Likewise, when the user moves to the left position 350, the user's gaze remains orthogonal to the screen 346, but is now pointed to the left of the screen 346. In this case, the virtual camera control system may compute a vector based at least in part on the user's position 350 and, in response, render region 344 of the XR environment 342 on the screen 346. As a result, the user is able to change their position relative to the screen and see a different portion or perspective of the XR environment. In some implementations, the virtual camera may adjust its view of the virtual environment to create a natural and immersive parallax effect from the user's perspective, all without requiring an input device or sensor-equipped headset.

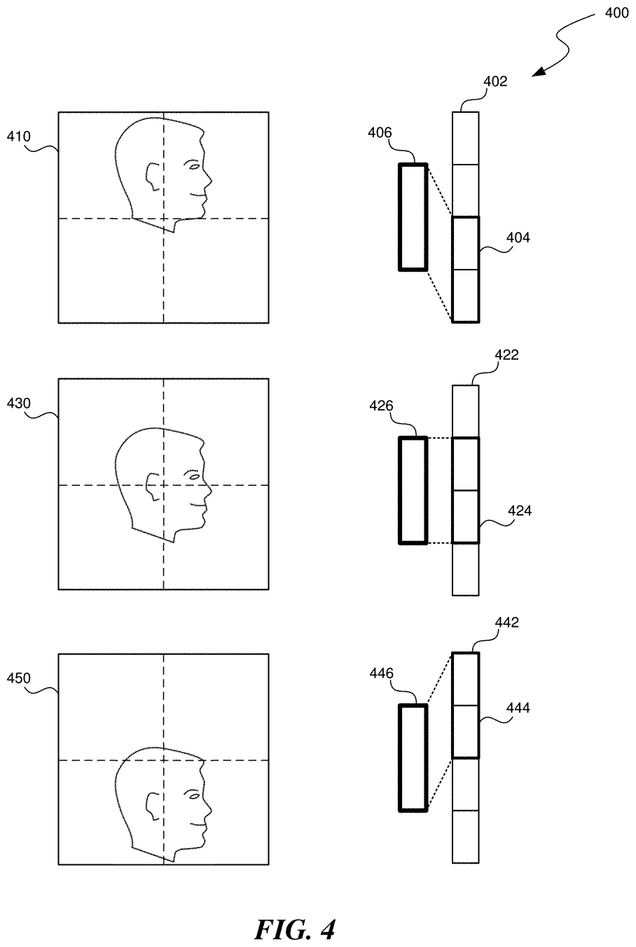

FIG. 4 is a conceptual diagram 400 illustrating a user controller a virtual camera by moving vertically to three positions: position 410 (above), position 440 (centered) and position 450 (below). When the user is centered with the screen at position 430, the user's gaze is both directed to the center of the screen 426 and is orthogonal to the screen 426. Accordingly, the virtual camera control system selects region 424 of XR environment 422 to render on the screen 426.

When the user moves to the above position 410, the user's gaze remains orthogonal to the screen 406, but is now pointed to above of the screen 406. Thus, the virtual camera control system may compute a vector based at least in part on the user's position 410 and, in response, render region 404 of the XR environment 402 on the screen 406 (e.g., enabling the user to see below what was rendered on the screen 426).

Likewise, when the user moves to the below position 450, the user's gaze remains orthogonal to the screen 446, but is now pointed below the screen 446. In this case, the virtual camera control system may compute a vector based at least in part on the user's position 450 and, in response, render region 444 of the XR environment 442 on the screen 446. As a result, the user is able to change their position relative to the screen and see a different portion or perspective of the XR environment. For example, by moving below the screen, the user may be able to see above what was rendered on screen 426, as if that user was looking out of a window into the real world.

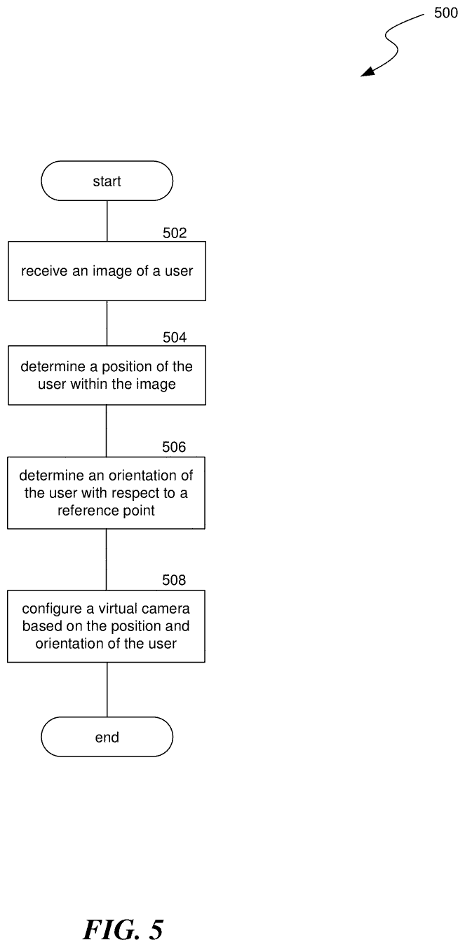

FIG. 5 is a flow diagram illustrating a process 500 used in some implementations of the present technology for controlling a virtual camera. In some implementations, process 500 can be performed on an artificial reality device, e.g., by a sub-process of the operating system, by an environment control “shell” system, or by an executed application in control of displaying an XR environment (e.g., a virtual camera control module). The process 500 is an example process for a virtual camera's position and orientation in an XR environment as discussed above. The process 500 may be performed periodically (e.g., at intervals to enable responsive or near-real time control of a virtual camera). In some cases, aspects of the process 500 (such as block 508) may be performed only if the process 500 detects a change in a user's pose relative to a previously determined user pose (e.g., a change in the vector of the user's gaze greater than some angle in vector space, using a metric such as cosine similarity).

At block 502, the process 500 can receive an image a user. The image may be captured by a user's smartphone, webcam, or another camera. In some embodiments, block 502 can include an image capture operation, wherein the process 500 causes a user's camera to capture an image or video frame (e.g., communicating with the camera as a peripheral directly, receiving image data from a streaming pipeline, etc.). In some implementations, the process 500 may be triggered in response to receiving an image from a camera as an input. In other implementations, the process 500 may control the user's camera to capture the image, with the image data being piped directly to the process 500 for subsequent processing.

At block 504, the process 500 can determine a position of the user within the image. The user's “position” may generally refer to a point or region within the image that is associated with the user. For example, the user's position may be defined by a region of three or more points (e.g., a 4-point bounding box from an object detection model, a multi-point bounded region from a semantic segmentation model, etc.). A geometric algorithm may be used to calculate or estimate the center of the region associated with the person. In some implementations, the user's position may be determined in 3D space, such as with 3D pose models that infer a bounding rectangular prism.

At block 506, the process 500 can determine an orientation of the user with respect to a reference point. The user's orientation may be the same as, derived from, or otherwise related to the direction of the user's gaze. For instance, a user may turn their head down and to the left, such that a 3D vector extending from the center of the person may point in that direction. The orientation of the user may thereby be determined as an angle in 3D space with respect to a reference axis, such as axes that run orthogonal to a camera or screen. The reference point relative to which the process 500 determines the user's orientation may be the location of the camera in 3D space, and/or the location of the screen used to render an XR environment.

At block 508, the process 500 can configure a virtual camera based on the position and orientation of the user. The process 500 may combine the position and orientation of the user to form a vector in 3D space (a “pose vector”). That pose vector may be compared against a reference vector to determine the extent to which the user has panned and/or tilted their head relative to being positioned in front of the screen or camera and relative to being oriented directly at the screen. The process 500 can use the pose vector to determine how to control the virtual camera's parameters—such as its position, orientation, zoom level, and/or other aspects of the virtual camera—to create a particular effect. In some cases, the process 500 might adjust the virtual camera in a way that creates a natural parallax effect, giving the impression to the user that they are looking through a window into the real world. In other cases, the process 500 can adjust the virtual camera to a lesser or greater degree than would be expected when interacting with the physical world (e.g., to provide for a subtle parallax effect, to provide for an exaggerated ability to look around a large environment within a limited range of positions and orientations, etc.).

A spectator mode can be activated in the headset of a first user (hereinafter referred to as a “playing user”) to enable a second user (hereinafter referred to as a “viewing user”) to see what is happening in a VR session. With the playing user's previously obtained permission, the viewing user has the ability to join in, from her own device such as her phone or a kitchen portal, to share what the playing user is experiencing in the headset. The process used to accomplish this is cross account casting. In existing systems, the playing user could cast only to a device registered on his own account or local network, e.g., his own phone or family television. The disclosed technology provides for registration between the accounts of the playing user and the viewing user. This registration allows the viewing user to initiate a spectator mode to view a casting session of the playing user's VR activities from her own device at any time. This enables the viewing user to join in the session, for example, by activating controls, e.g., hitting a displayed button. The viewing user initiating the spectator mode is analogous to a parent knocking on a child's door and peeking in. By accepting the viewing user's registration request, the playing user has already agreed to allow the playing user to monitor his screen. Moreover, the registration process can define the operation of the spectator mode, setting up agreed-upon permissions and limitations. Once the registration is complete, the viewing user may initiate a request to start a casting session at any time, and, in some cases, the request can be automatically granted based on the previous registration acceptance or, in other cases, the request can be provided to the playing user to approve each particular casting session.

The following examples refer to a parent and child setting. However, the disclosed technology can be used between any two accounts. Thus, the term “child” will refer to the person using the headset (the playing user) and the term “parent” will refer to the person requesting spectator status (the viewing user). It will be understood that the terms “child” and “parent” are used to identify persons performing the indicated actions, and that these terms are not limited to persons having any familial relationship.

In a first example, the child can be playing a game on the headset. The parent, who previously registered with the child's account, can start spectator mode to initiate a casting session and the parent will appear on the headset screen, e.g., in a subscreen at a corner of the headset screen specified for indicating that the spectator mode is active. The appearance of the parent can be, e.g., in the form of a still picture, video, or avatar, which alerts the child to the fact that the parent has joined. The parent can see and hear what the child is experiencing and what the child is saying, and the child can hear what the parent is saying. The parent can then interact with the child in the VR session, e.g., by announcing “dinner in 10 minutes” or asking a question such as “what are you playing?”

In existing VR systems that enabled casting, the users could not hear each other. The disclosed technology provides live communications between the users. Continuing the above example, in some implementations, when the parent has enabled spectator mode, both parent and child can converse with each other, e.g., allowing the child to ask for help. For example, the child could ask for a forgotten password to the WiFi or other app, report to the parent abusive behavior of another user, or ask the parent to suggest the next move in playing a game. In this way, the parent can be considered a co-pilot, providing assistance while the child remains in control.

In another example, the child wants to start playing a new game. In spectator mode, the parent can watch the game along with the child for a while, to see if the game is appropriate or not for the child. If the parent has any questions, she can ask the child and point specifically to images or words that may be objectionable. Correspondingly, the child can offer an explanation or background that may remove the parent's objection. Previously, the child and parent might have to sit side by side on the sofa watching the living room TV. That situation could distort the context of material that the parent might object to, but which the child might be able to explain about how his peers might see it. Conversely, the parent might be able to explain better why certain images or dialog are more problematic than the child realizes at first glance.

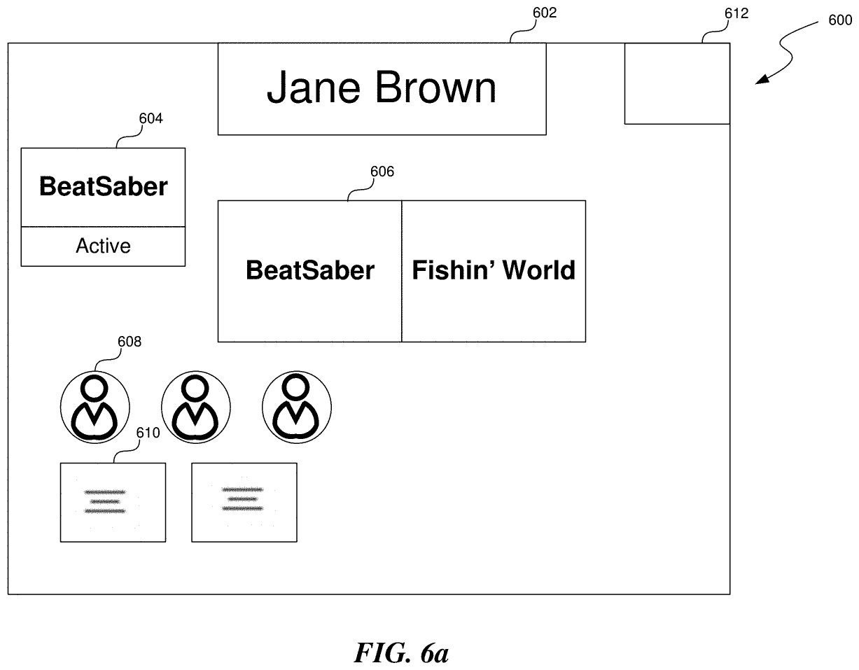

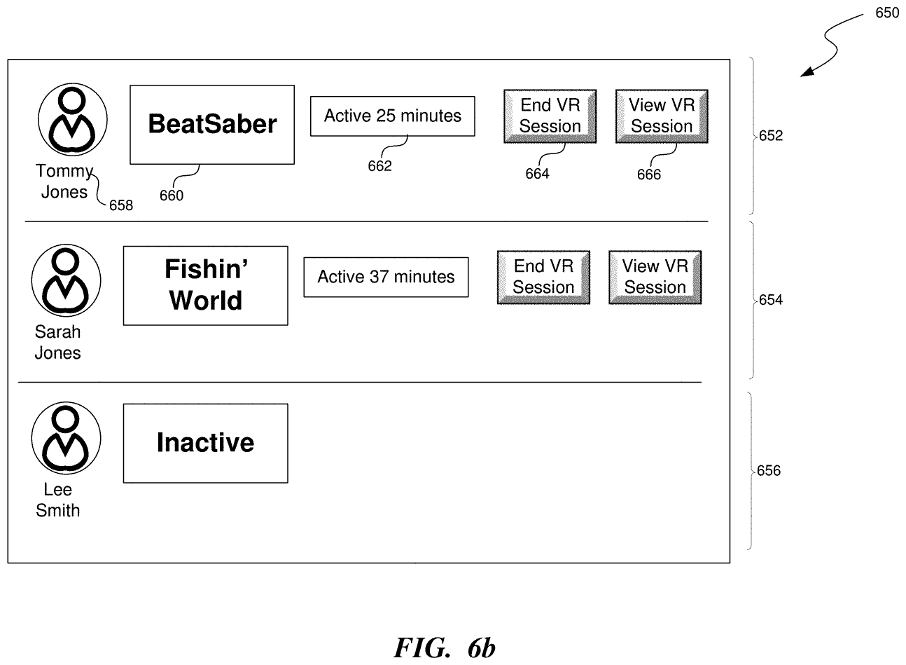

FIG. 6a is an example 600 of a dashboard displayed on the screen of a device of a playing user on which the spectator mode may be established in the case where a viewing user's account has already been registered with the playing user's account. In FIG. 6a, the dashboard 600 includes the playing user's ID 602 and a panel 604 indicating what apps are currently active. In example 600, the only active app is a game, e.g., BeatSaber. Example 600 also includes a panel 606 indicating apps that are available, e.g., for game playing. Panel 608 indicates friends of the playing user, and panel 610 indicates profiles of the playing user.

FIG. 6b is an exemplary view 650 into a viewing user's dashboard on which the viewing user may request spectator mode for one of multiple connected accounts. The viewing user's device may be a phone or any other portal. The viewing user's device presents a dashboard containing a list of accounts 652, 654, 656 registered to be viewed by the viewing user through spectator mode. In FIG. 6b, the playing users associated with accounts 652 and 654 are each currently active in a respective VR session, and the playing user associated with account 656 is identified as inactive, i.e., not currently active in a VR session. Looking at the example of account 652, the playing user 658 is identified as playing a game (BeatSaber), as shown in area 660, and has been active in the VR session for 25 minutes, as shown in area 662. Button 664 may be actuated by the viewing user to end the current VR session of playing user 658, if this operation has been agreed to during registration. Button 666 may be actuated by the viewing user to send a request to playing user 658 for entering spectator mode to view the playing user's VR session. Depending on the permissions agreed to during registration, in some implementations the playing user 658 is notified of this request, and she can then accept or deny the request. Alternatively, again depending on the permissions agreed to during registration, in some implementations the request may be automatically accepted, or may be automatically denied if the playing user 658 does not respond to the request in a defined time, e.g., within 5 or 10 seconds of receiving the request. If the request is accepted, spectator mode is initiated for the viewing user, as discussed below. Corresponding display areas/buttons are provided as appropriate for each other registered account 654, 656.

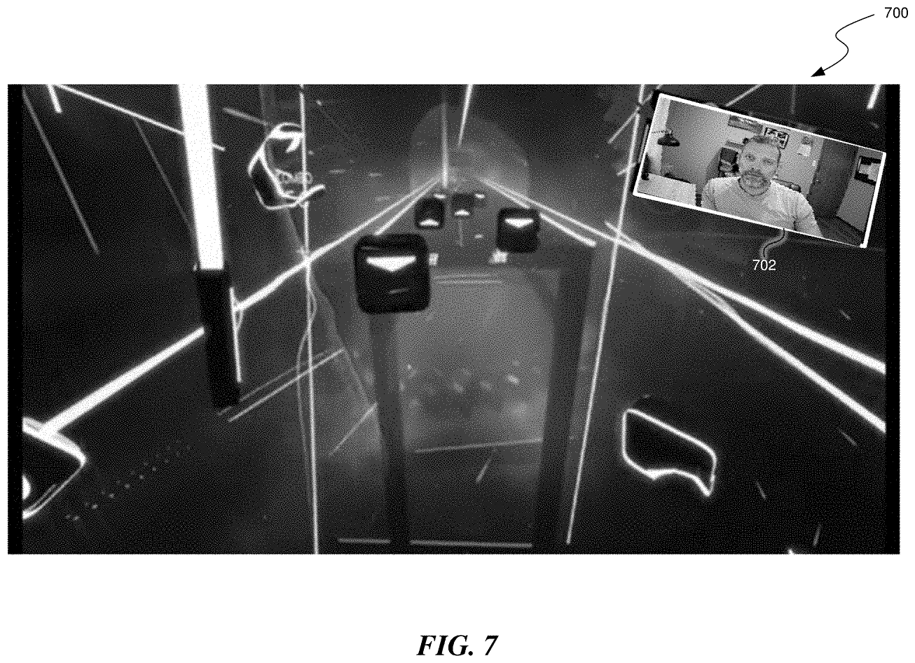

FIG. 7 is an exemplary view 700 into the playing user's VR session in which the spectator mode is active. In example 700, the main area of the playing user's screen shows the VR environment, e.g., the game being played. The area 702 is a subscreen area that identifies the viewing user, who is now spectating, using a still picture, video, or avatar. In the spectator mode, the viewing user now sees on her phone or other portal what the playing user sees in the VR session, i.e., she sees the game being played. In some cases, she may also see herself in area 702. In some instances, while viewing the casting session through the spectator mode, the viewing user can block one or more identified apps or can disapprove of one or more of the identified friends. The viewing user may also be able to shut down a current experience.

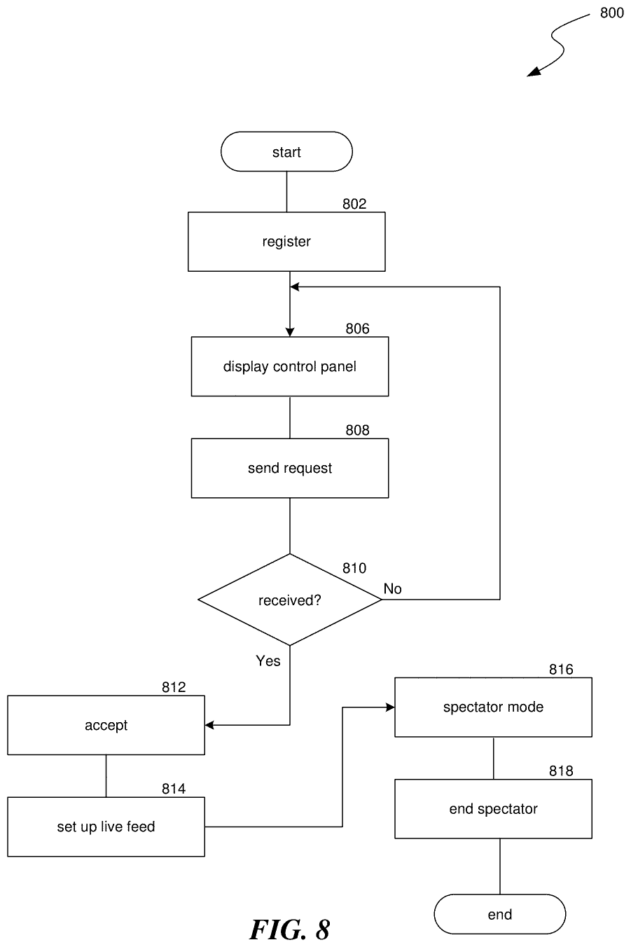

FIG. 8 is a flow diagram illustrating a process 800 for requesting the spectator mode used in some implementations.

At block 802, process 800 can register a viewing user's account with a playing user's account. In some implementations, the registration process of block 802 can be a one-time process, whereby the registration remains in effect until canceled by one or both users. In some implementations, the registration process of block 802 can be required each time the viewing user wants to activate the spectator mode. The operations in block 802 are further discussed below.

In block 806, a user is presented with a control panel including a display of the other users who have accounts registered with the viewing user. For example, if the control panel shows that one of these users is a playing user currently active in a VR session, the control panel can include a button to start a casting session from the account of that playing user.

At block 808, the viewing user can then actuate a control, e.g., a send request button, to send a request to initiate spectator mode to the selected account, and process 800 sends the viewing user's request to the playing user's device, e.g., the headset, which will function as the casting device if the request is accepted by the playing user. The request is formatted in accordance with the permissions and agreements set up during the registration in block 802, and may have a predefined or individualized format. In the example of FIG. 8, it is assumed that that the viewing user selects the account of the currently active playing user. Alternatively, the viewing user can select the account of a user who is currently not in a VR session, using additional protocols for contacting that user.

At block 810, process 800 can determine if the playing user's account has received a proper request from the viewing user. If, for example, a request is improper for identifying a blocked user, the answer in block 810 can be treated as NO, and process 800 returns to block 806. If the request is proper, process 800 can determine if the request is accepted or denied. Depending on the permissions agreed to during the registration process, the request may be accepted or denied in various ways or under different conditions. For example, the request may be automatically accepted. Alternatively, the headset may display a button or other control that the playing user may actuate to accept or deny the request, or the request may be automatically denied if the playing user does not respond to the request in a defined time, e.g., within 5 or 10 seconds of receiving the request. In some implementations, the permissions may permit acceptance only in certain circumstances. For example, the request may be accepted for a particular viewing user only limited experiences, e.g., only to play certain games, or for a limited time, or only during certain times during the day. The request may be accepted or denied based on the age or personal characteristics of the playing user and/or the viewing user. Also, express acceptance may be required for each request, or only during onboarding, or may be required for a first request from a particular viewing user and be automatic for that viewing user thereafter. In some implementations, the acceptance/denial can be performed by a gaze command, a gesture command, a button, and the like. If the request is denied for any reason, the answer in block 810 is NO, and process 800 returns to block 806.

If the answer in block 810 is YES, process 800 moves to block 812, wherein the playing user's device accepts the request and process 800 moves to block 814 to begin the implementation of the spectator mode with the requesting viewing user.

At block 814, the playing user's headset sets up a live feed (pipeline) between the headset and the viewing user's device to cast the audio/video of the playing user's point of view in the VR session to the viewing user's device. This can be done using different methods, such as casting, calling (audio), or camera (video).

At block 818, the spectator mode becomes active, so that the viewing user now sees on her device (phone or other portal) what the playing user sees in the VR session, e.g., the viewing user sees the game being played the way the playing user sees it. In addition, the playing user and, in some cases also the viewing user, may see an indication that the spectator mode is active and who the viewing user is. In this way, both the playing user and the viewing user are aware in the VR session that the spectator mode is active.

At block 818, either the playing user or the viewing user may end the spectator mode. In some implementations, the playing user may actuate a control to end the spectator mode while continuing the VR session, or the playing user may simply end the VR session. Correspondingly, in some implementations, the viewing user may actuate a control on her device to exit the spectator mode or close her device. In some implementations, depending on the registration permissions, the viewing user may have the authority to end the VR session itself. Process 800 then ends.

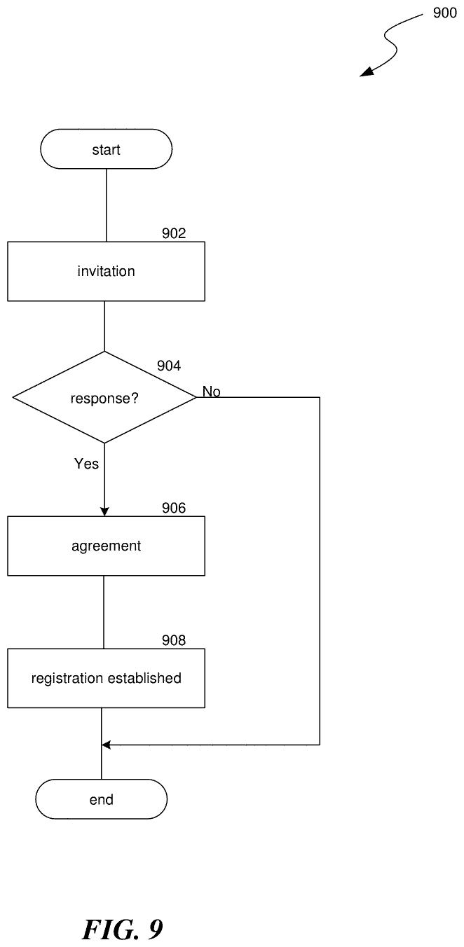

FIG. 9 is a flow diagram illustrating a process 900 for performing registration for cross account casting used in some implementations. In some implementations, the registration process may be performed using the parental supervision tool.

Registration is advantageously simple for the users, but it is also advantageous to have different requirements and permissions for different potential viewing users. For example, registration should be relatively straightforward for parent-to-child cross account casting, because the parent and child can discuss the process and come to an agreement of the responsibilities and opportunities of both parties. Correspondingly, if the potential playing party is a car owner and the potential viewing party is the mechanic working on the car, it is advantageous to have the registration process for such a limited interaction between known parties to be simple. On the other hand, registration between accounts of a young person and a friend may need to be more investigative. The parent may wish to know more about who is communicating directly with their child. The registration process needs to be individualized to ask the proper questions and minimize risks to users. This can obviate the need for continual supervision by determining the trustworthiness of the potential viewing users at the outset.

The registration process 900 begins in block 902. Here, process 900 can send an invitation from a playing user, i.e., the user who invokes a VR session on his headset, to a potential viewing user, e.g., a parent to cross account register so as to enable a spectator mode. This invitation can be sent in a variety of ways, e.g., by sending a unique invite line. This can be done using a speciation, link, QR code, or other way to link the accounts between devices. The communications for registration go through any supporting servers.

At block 904, process 900 determines whether the invited viewing user has responded favorably to the invitation within a predetermined period of time, e.g., 24 hours. If the answer at block 904 is NO, process 900 ends.

If the answer at block 904 is YES, at block 906, the playing user and the viewing user reach an agreement through the use of a registration screen. Through the registration screen, the playing user and the viewing user exchange information to reach an agreed-upon level of permissions, e.g., privacy settings, automated viewing agreements, etc. Depending on the permissions agreed to, a later request to invoke the spectator mode may be accepted or denied in various ways or under different conditions. For example, the request may be automatically accepted. Alternatively, the playing user may be required to actuate a control to accept or deny the request, or the request may be automatically denied if the playing user does not respond to the request in a defined time, e.g., within 5 or 10 seconds of receiving the request. In some implementations, the permissions may permit acceptance only in certain circumstances. For example, the request may be accepted for a particular viewing user only for limited experiences, e.g., only to play certain games, or for a limited time, or only during certain times during the day. The request may be accepted or denied based on the age or personal characteristics of the playing user and/or the viewing user. Also, express acceptance may be required for each request, or only during onboarding, or may be required for a first request from a particular viewing user and be automatic for that viewing user thereafter.

At block 908, process 900 can establish the registration for cross account casting incorporating the agreed-upon permissions, etc. For example, linked accounts can be specified in a join table, indicating the user account identifiers for the linked accounts. In some cases, the registration is processed through the back end, e.g., through servers supporting the VR environment.

In some implementations, for example, when the viewing party, e.g., a parent, is acting in the co-pilot mode, each cross account casting can be set up to last a limited amount of time, or be permitted for only certain, limited experiences, or may require a new authorization for each session. The voices of the playing user and/or the viewing user may be sent through the caster system.

In some implementations, depending on the agreed permissions, the viewing user can take control over the session, e.g., operating pointing and actuation controls and making choices for the playing user. In some implementations, the playing user can request the viewing user to join in spectator mode in order to, e.g., help or cheer on the playing user.

In some implementations, multiple users can spectate simultaneously, whether they are physically together or separate. In some cases, if the playing user has determined that the registered viewing users can be trusted and has decided that he does not need to see who is spectating, the identities of the viewing user(s) do not need to be displayed, thereby saving screen space and/or avoiding distraction.

In some implementations, the playing user can allow spectating when the playing user is playing one particular game, but not while playing a different game. In some cases, the playing user can allow spectating only at certain times, or during certain modes of operation.

In some implementations, the cross account casting can operate in a passthrough mode, where the playing user and/or the viewing user can see objects in both the VR environment and in the real world. This mode can be advantageous if, for example, the one user wishes to assist the other user with some circumstance in the real world, and the help can be sent through the VR session. However, for privacy reasons, special permission can be required to operate in the passthrough mode. In addition, the VR session can be controlled to give a warning or automatically end if a user begins to operate in the passthrough mode without consent.

It is important to develop tools for capturing such VR experiences as a video, and to develop additional tools for sharing the videos to social media platforms. For example, there is a VR game in which court cases can be experienced, but some users may not know that this world exists or how it works. Tools need to be developed to capture such worlds, for example, in a video and share it with friends so that more users have the chance to join in.

Methods and systems are provided to implement the capture of images of events, e.g., experiences, in a VR environment in order to generate and present a video (e.g., a short-form video) that may be posted to social media platforms. The capture is performed using one or more virtual cameras that are spawned in the VR environment. The view from each virtual camera is presented as part of a virtual device, e.g., a virtual phone, that the user can manipulate in the VR environment to send content to the physical computing system supporting the VR environment. Thus, each virtual camera may be activated to produce a feed taken from a respective viewpoint of the events in the VR environment. Each virtual camera takes pictures/video from wherever it is fixed or from wherever it is moved. For example, one virtual camera may be fixed in position, another virtual camera may be static but adjustable in zoom, camera angle, or between portrait/landscape orientation, another virtual camera can be held in the hand of the user's avatar, and still another virtual camera may be mounted on a virtual drone to move about within the VR world (e.g., to automatically follow an avatar or virtual object).

The feeds may be in the form of, e.g., recorded pictures or video. The feeds may also be live streamed, e.g., to a social media platform. These feeds may be edited in a separate system or in the VR environment to create content, e.g., a short-form video from the one or more viewpoints of the respective virtual cameras. In particular, a video may be created from a single feed from one virtual camera. Alternatively, a video may be created by stitching together features from two or more feeds. The video may be further edited, e.g., in a editing panel within the VR environment or, for example, by an app on a physical phone of the user.

Each virtual camera can have virtual controls that are displayed for the user to control its operation. Advantageously, the controls can be in a format corresponding to conventional controls on a physical camera. This makes the control of the virtual camera intuitive and familiar to the user. Thus, each virtual camera may have virtual buttons, switches, lights, etc. that the user can activate, e.g., by gaze, gesture, VR headset, or VR controller, to enable the user to turn it on/off, take a picture, begin/stop video recording, live stream, switch from the front-facing camera to the back-facing camera, select settings, etc. A virtual camera that can operate as a static adjustable virtual camera has controls for making these adjustments. Similarly, a virtual camera that can be operated as a drone virtual camera can have controls for moving it around the VR environment in a manner corresponding to the operation of physical drone camera. For example, the drone virtual camera can respond to remote control commands to move under the concurrent input from the user, or it can be commanded to move in a pre-programmed pattern. The drone virtual camera can also be commanded to operate in a “follow me” manner to track the movements of the user's avatar, another avatar, or a virtual object in the VR environment.

The video may then be shared to the user's account on a social media platform, shared directly to friends, stored for later viewing, etc. The shared video may then be further edited on the social media platform, for example, to add a link to the VR world in which the video was created. The final edited version of the video may then be posted on the social media platform, and people with permission can view the posted video on the user's account.

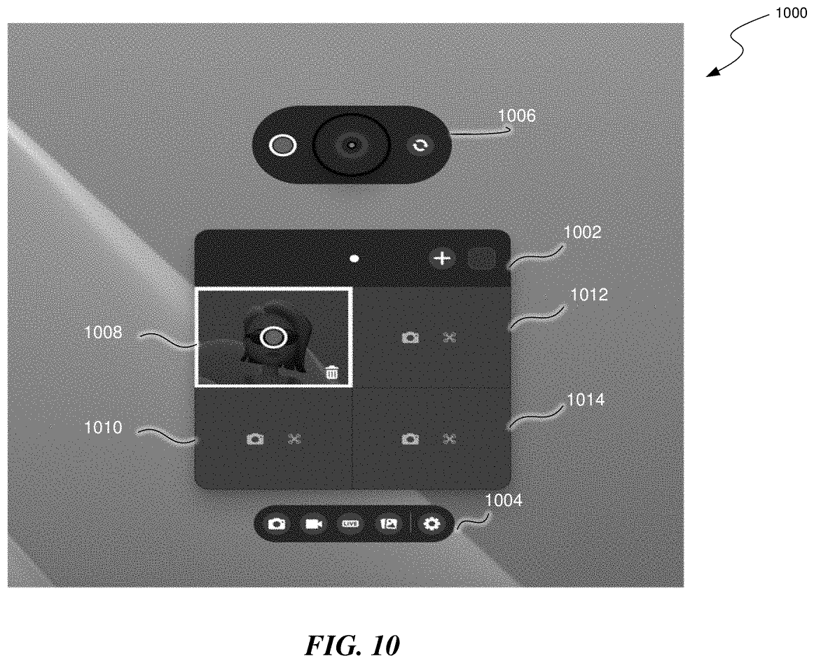

FIG. 10 is an exemplary view 1000 into a VR environment showing a virtual device 1002, operating in conjunction with cameras such as a virtual drone camera 1006, to capture viewpoints of experiences in the VR world. Virtual device 1002 includes a user interface (UI) having remote controls 1004. In some implementations, the remote controls 1004 are arranged in a conventional format for a physical drone camera to support its operation. The feeds 1008, 1010, 1012, 1014 from four virtual cameras (including virtual camera 1006) are provided on the virtual device 1002 for capturing respective viewpoints to create a video. In FIG. 10, only virtual camera 1006 is currently recording. Each of the virtual cameras viewpoints 1008, 1010, 1012, 1014 may be independently moved and operated as controlled by the user using the remote controls to capture the respective viewpoints.

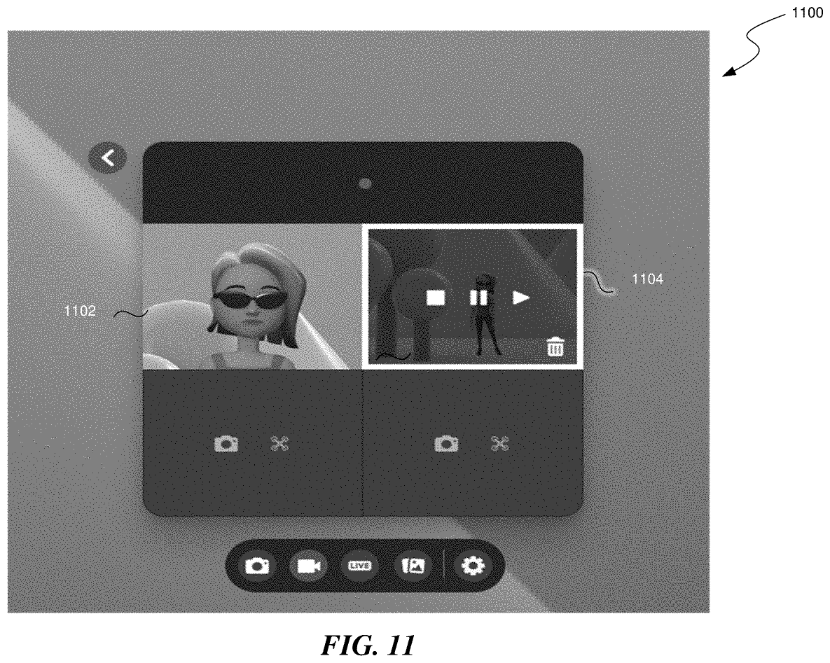

FIG. 11 is an exemplary view 1100 into a VR environment showing a virtual device connected to four virtual cameras. In FIG. 11, virtual cameras feeds 1102, 1104 are currently recording video to capture two different viewpoints of experiences in the VR world. Virtual camera feed 1102 is recording video of a close-up view of an avatar's face, while virtual camera feed 1104 is recording video of a full-figure view of the avatar. As discussed below, portions of each feed may be selected and stitched together when editing the feeds into a video. Each of the four virtual cameras can record video for a period of time, which may be up to a predetermined maximum, e.g., 30 seconds or 50 seconds.

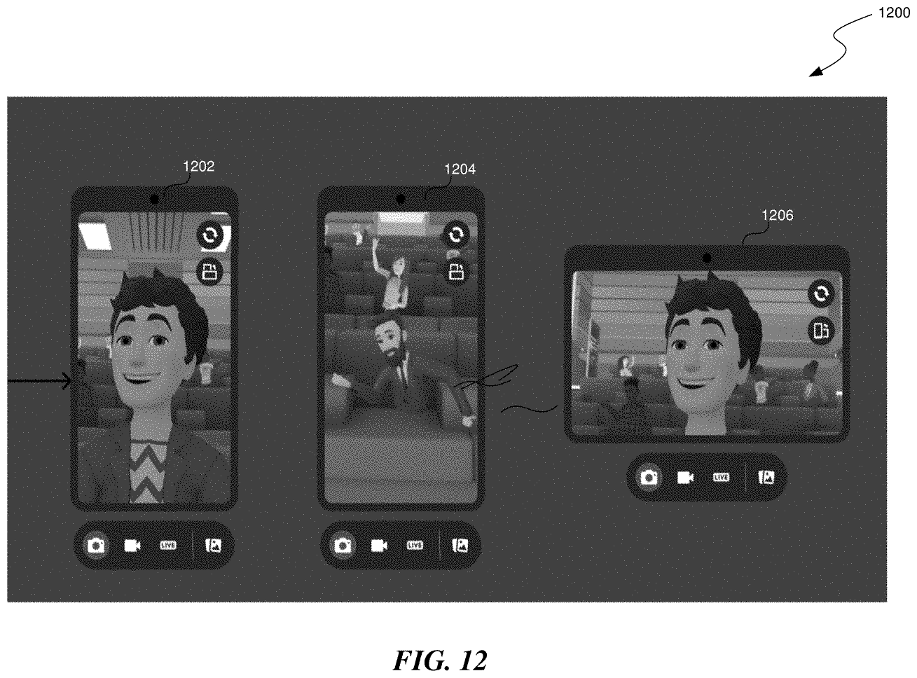

FIG. 12 is an exemplary view 1200 into a VR environment in which a virtual camera has been positioned and then fixed in place by the user. The fixed virtual camera then operates as if it were a physical camera attached to a tripod, i.e., the user's avatar can move within the VR world while the fixed virtual camera continues to take pictures/video from its fixed position. The virtual camera can be fixed by, for example, using the combination of Hover+Hardpress (holding the trigger) on the VR controller to allow movement and repositioning of the virtual camera. When the trigger is released, the virtual camera is dropped into its new, fixed position. In some implementations, photos are then controlled by the trigger and video recording is controlled by the UI remote controls on the virtual phone. In this case, there is a defined range for these video remote controls.

However, the fixed virtual camera can still be manipulated to show different viewpoints at that fixed position. In FIG. 12, the feed 1202 from the fixed virtual camera shows an avatar in the picture orientation from the front-facing camera. In response to the virtual remote controls, the feed 1204 shows different avatars in the picture orientation from the back-facing camera, and the feed 1206 shows the first avatar from the front-facing camera in the landscape orientation. Other micro-adjustments can also be made with a fixed virtual camera. For example, in response to the virtual remote controls, the camera can zoom in and out, or the camera angle can be adjusted, as if a physical camera were rotated around an axis.

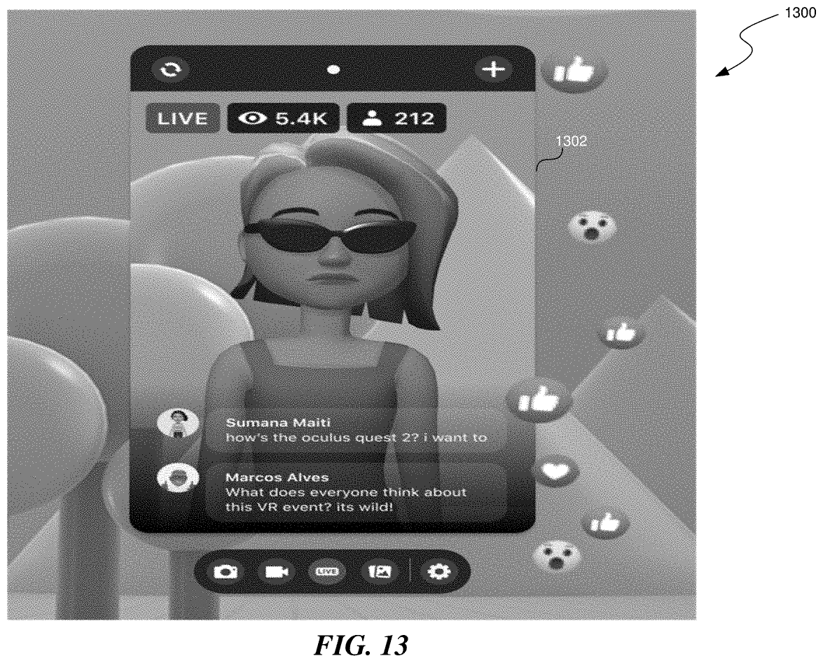

FIG. 13 is a fourth exemplary view into a virtual reality (VR) environment showing live streaming of a video of a feed 1302 from a virtual camera in a VR environment to a social media platform.

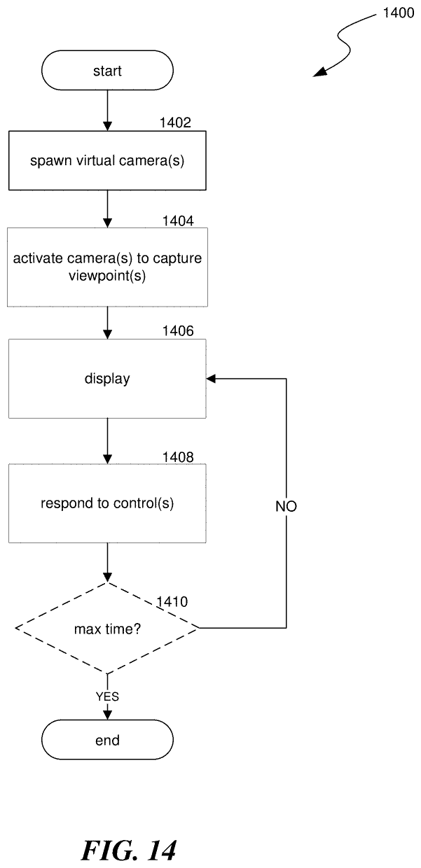

FIG. 14 is a flow diagram illustrating a process 1400 for implementing capture of a video using one or more virtual cameras. In step 1402, process 1400 can spawn one or more virtual cameras to implement the capture of images of events, e.g., experiences, in a VR environment in order to generate and present a video. Each virtual camera can take pictures/video or live-stream video from wherever it is fixed or from wherever it is moved. For example, in some implementations, one virtual camera may be fixed in position, while another virtual camera may be static but adjustable in zoom, camera angle, or between portrait/landscape orientation, and still another virtual camera may appear to be mounted on a drone to move about within the VR world.

In step 1404, the process 1400 can activate one or more of the virtual cameras to take pictures, record video, or live stream. In some implementations, the virtual camera can be activated to either take pictures, record video, or live stream in response to the user operating the remote controls on the UI of the virtual camera, corresponding to the photo/video/live stream controls on a physical camera. In some implementations, the activated virtual camera can take pictures in response to pulling a trigger on a VR controller, making a gesture, speaking a command, etc. In some implementations, the virtual camera can record video or live stream in response to the remote controls on the UI. Once activated for video recording, each of the virtual cameras can record video for a period of time, which may be up to a predetermined maximum, e.g., 30 seconds or 50 seconds.

In step 1406, the process 1400 can display the feed from each activated virtual camera so that the user can see what each virtual camera is capturing. In some implementations, when multiple virtual cameras are activated, the multiple feeds can be handled in the same way as a network would handle multiple feeds from multiple cameras. The feeds can be shown in a template, such as a switcher board view, where the user can view all independent but concurrent feeds together. This enables on-the-fly changes, for example, by adjusting the angle of a fixed virtual camera or the motion of a drone virtual camera in order to catch the desired viewpoint. The switcher board view also enables on-the-fly editing, where the user can create and edit a video by choosing and stitching together features from the different feeds. Alternatively, the stitching may be performed by an AI system to identify which feed is the most relevant according to the user's predetermined instructions and to auto-stitch the selected feeds together.

In step 1408, process 1400 can respond to user activation of controls, including controls on the VR controller and controls on the UI of the virtual cameras. For example, in some implementations, the user may have seen on one displayed feed that the respective fixed virtual camera is recording at the wrong angle, and so the user may use the controls to change the angle. In some implementations, the user may similarly use controls to turn virtual cameras on or off, move drone virtual camera, zoom in or out, or effect any other desired changes. The result of any of such changes will then appear on the display in step 1406.

While any block can be removed or rearranged in various implementations, block 1410 is shown in dashed lines to indicate there are specific instances where block 1410 is skipped—e.g., where recording continues back to block 1406 until a user command to stop is provided. In step 1410, process 1400 can determine whether video recording has been continuing for the maximum time period. In some implementations, if video recording has reached the maximum time period for one camera, all video recording by all the virtual cameras can stop and process 1400 ends. In some implementations, if video recording has reached the maximum time period for one camera, but not for all virtual cameras, then video recording by the virtual cameras that have reached the maximum stops, but the other virtual cameras can continue to record. In this latter case, after step 1410, process 1400 returns to step 1406 to display the current feeds.

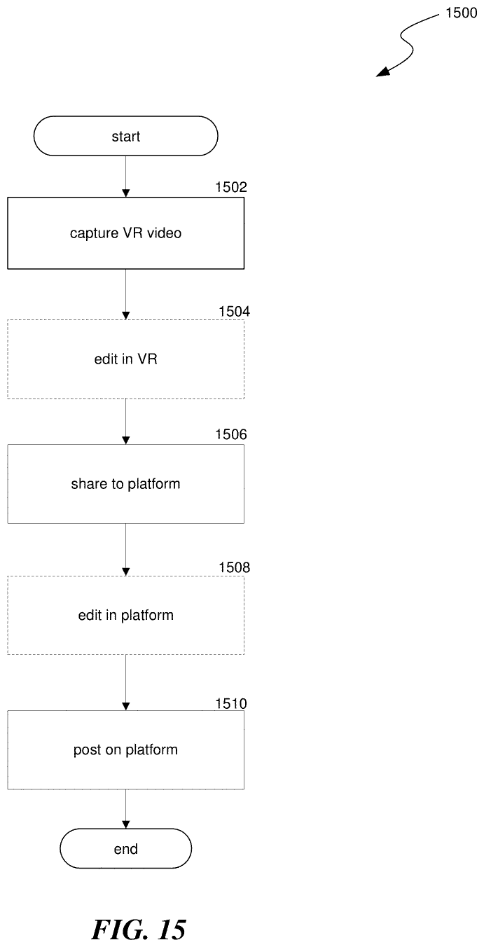

FIG. 15 is a flow diagram illustrating a process for editing a video for posting to a social media platform. In step 1502, process 1500 can capture a video—e.g., as discussed above.

While any block can be removed or rearranged in various implementations, block 1504 is shown in dashed lines to indicate there are specific instances where block 1504 is skipped. In step 1504, process 1500 can optionally edit the video in the VR environment. In some implementations, step 1504 can be performed as described above, but process 1500 is not limited to these implementations, and a video can be captured and/or edited in a VR environment in other ways.

Regardless of whether in step 1504 editing in VR is performed, in step 1506, process 1500 can share the video to another platform, e.g., a social media platform, to another user via a messaging platform, to a storage platform, etc. In some implementations, the user's phone (or other computing system) may include a share button. Upon hitting the share button, the phone may have a view to preview video, and this preview may present a number of options for actions to take regarding the video. One option may be to edit the video in VR, which the user may perform before sharing to another platform. The phone may include an editing panel for editing in VR, such as adding filters, tagging, setting up permissions, etc.

Another option in the video preview may be to display a list of platforms to share the video to. If the user selects a platform for which he has a completed account, the video is shared to the selected platform. When the user does not have a completed account with the selected platform, he can set up or complete his account, including setting up a link between his VR account and the account of the selected platform. The user can also set permissions as to who will be allowed to see the video on the platform, and set metadata for sharing, e.g., adding a description or sticker to the video. The user can also tag selected people who he wishes to see the video. These and/or other options may be available depending on which platform is selected. The video is then shared to the selected platform

While any block can be removed or rearranged in various implementations, block 1508 is shown in dashed lines to indicate there are specific instances where block 608 is skipped. In step 1508, process 1500 can further edit the video on the platform. The user may edit the video on the platform as soon as the video is shared. Alternatively, the user can wait until the next time he pulls up that platform.

The editing in step 1508 may include adding a link to the video that links back to the world in which the video was created. In this way, the user's friends who have permission to view the video and are intrigued by this previously unknown world automatically have a way to access that new world.

Then in step 1510, the video is posted to the selected platform, and process 1500 ends.

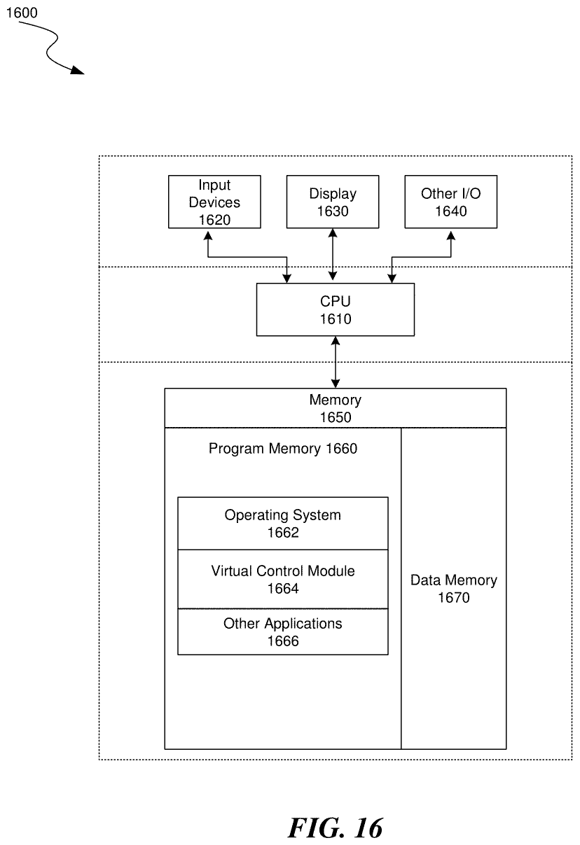

FIG. 16 is a block diagram illustrating an overview of devices on which some implementations of the disclosed technology can operate. The devices can comprise hardware components of a device 1600 as shown and described herein. Device 1600 can include one or more input devices 1620 that provide input to the Processor(s) 1610 (e.g., CPU(s), GPU(s), HPU(s), etc.), notifying it of actions. The actions can be mediated by a hardware controller that interprets the signals received from the input device and communicates the information to the processors 1610 using a communication protocol. Input devices 1620 include, for example, a mouse, a keyboard, a touchscreen, an infrared sensor, a touchpad, a wearable input device, a camera- or image-based input device, a microphone, or other user input devices.

Processors 1610 can be a single processing unit or multiple processing units in a device or distributed across multiple devices. Processors 1610 can be coupled to other hardware devices, for example, with the use of a bus, such as a PCI bus or SCSI bus. The processors 1610 can communicate with a hardware controller for devices, such as for a display 1630. Display 1630 can be used to display text and graphics. In some implementations, display 1630 provides graphical and textual visual feedback to a user. In some implementations, display 1630 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 1640 can also be coupled to the processor, such as a network card, video card, audio card, USB, firewire or other external device, camera, printer, speakers, CD-ROM drive, DVD drive, disk drive, or Blu-Ray device.

In some implementations, the device 1600 also includes a communication device capable of communicating wirelessly or wire-based with a network node. The communication device can communicate with another device or a server through a network using, for example, TCP/IP protocols. Device 1600 can utilize the communication device to distribute operations across multiple network devices.

The processors 1610 can have access to a memory 1650 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 1650 can include program memory 1660 that stores programs and software, such as an operating system 1662, virtual control module 1664, and other application programs 1666. Memory 1650 can also include data memory 1670, which can be provided to the program memory 1660 or any element of the device 1600.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

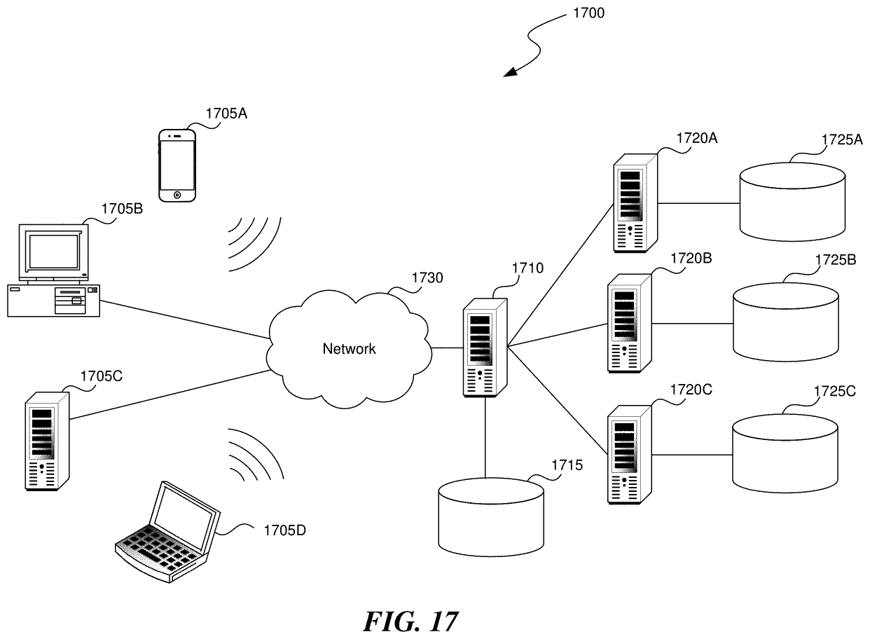

FIG. 17 is a block diagram illustrating an overview of an environment 1700 in which some implementations of the disclosed technology can operate. Environment 1700 can include one or more client computing devices 1705A-D, examples of which can include device 1600. Client computing devices 1705 can operate in a networked environment using logical connections through network 1730 to one or more remote computers, such as a server computing device.

In some implementations, server 1710 can be an edge server which receives client requests and coordinates fulfillment of those requests through other servers, such as servers 1720A-C. Server computing devices 1710 and 1720 can comprise computing systems, such as device 1600. Though each server computing device 1710 and 1720 is displayed logically as a single server, server computing devices can each be a distributed computing environment encompassing multiple computing devices located at the same or at geographically disparate physical locations. In some implementations, each server 1720 corresponds to a group of servers.

Client computing devices 1705 and server computing devices 1710 and 1720 can each act as a server or client to other server/client devices. Server 1710 can connect to a database 1715. Servers 1720A-C can each connect to a corresponding database 1725A-C. As discussed above, each server 1720 can correspond to a group of servers, and each of these servers can share a database or can have their own database. Databases 1715 and 1725 can warehouse (e.g., store) information. Though databases 1715 and 1725 are displayed logically as single units, databases 1715 and 1725 can each be a distributed computing environment encompassing multiple computing devices, can be located within their corresponding server, or can be located at the same or at geographically disparate physical locations.

Network 1730 can be a local area network (LAN) or a wide area network (WAN), but can also be other wired or wireless networks. Network 1730 may be the Internet or some other public or private network. Client computing devices 1705 can be connected to network 1730 through a network interface, such as by wired or wireless communication. While the connections between server 1710 and servers 1720 are shown as separate connections, these connections can be any kind of local, wide area, wired, or wireless network, including network 1730 or a separate public or private network.

Embodiments of the disclosed technology may include or be implemented in conjunction with an artificial reality system. Artificial reality or extra reality (XR) is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a passthrough display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof. Additional details on XR systems with which the disclosed technology can be used are provided in U.S. patent application Ser. No. 17/170,839, titled “INTEGRATING ARTIFICIAL REALITY AND OTHER COMPUTING DEVICES,” filed Feb. 8, 2021 and now issued as U.S. Pat. No. 11,402,964 on Aug. 2, 2022, which is herein incorporated by reference.

Those skilled in the art will appreciate that the components and blocks illustrated above may be altered in a variety of ways. For example, the order of the logic may be rearranged, substeps may be performed in parallel, illustrated logic may be omitted, other logic may be included, etc. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc. Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for controlling a virtual camera in an artificial reality (XR) environment, the method comprising:
receiving, from a camera, an image of a user;
determining, from the image of the user, a position of the user within the image;
determining, by a pose estimation model, an orientation of the user with respect to the camera; and
configuring at least one of an orientation and position of a virtual camera based on the determined position and orientation of the user, wherein the virtual camera is used by an XR system to determine a portion of an XR environment to render on a screen.

2. A method for implementing a spectator mode in a virtual reality environment, the method comprising:
authorizing a potential spectator as a registered spectator by registering an account of the potential spectator with an account of a user of a virtual reality device;
receiving, at the virtual reality device, a request from the registered spectator for permission to operate in a spectator mode during a virtual reality session, wherein the spectator mode enables the registered spectator to communicate with the user in a virtual reality environment during the virtual reality session; and
responding to the request by permitting the registered spectator to operate in the spectator mode during the virtual reality session.

3. A method for presenting a video using one or more virtual cameras, the method comprising:
spawning one or more virtual cameras in a VR environment;
activating the one or more virtual cameras to capture respective viewpoints of events in the VR environment; and
generating a video based on the captured viewpoints.
